(19) United States
(12) Patent Application Publication
(10) Pub. No.: US 2012/0119877 A1
(43) Pub. Date: May 17, 2012

(54) PROGRAMMABLE ELECTRONIC LOCKBOX SYSTEM

(76) Inventors: Kwan Yuen Abraham Ng, EI Monte, CA (US); Sarah Seen Yui Chan Ng, EI Monte, CA (US)

(21) Appl. No.: 12/944,677

(22) Filed: Nov. 11, 2010

(51) Int. Cl. G08B 29/00; E05B 37/00; E05B 47/00

(52) U.S. Cl. 340/5.61; 340/5.2; 70/276; 70/286

(57) ABSTRACT

A programmable lock system is provided for access restricting and user tracking. The system includes a lock mechanism, a microcontroller, and an input device for receiving passing information. The microcontroller reads the received passing information and determines whether to unlock the lock mechanism. The system further includes an inlet for receiving an external storage with pre-programmed code. The microcontroller determines whether to access data contained therein based on the pre-programmed code.

### FIELD OF THE INVENTION

The present invention generally relates to lockboxes. More particularly, the invention relates to a programmable electronic lockbox system.

### BACKGROUND

Lockboxes are commonly used in the real estate sales industry to provide a means for a large number of salesmen to conveniently gain access to locked buildings. A typical lockbox includes an inner repository that can be used to store a key to a building. The inner repository of the lockbox can be accessed by opening a door attached to the lockbox. A combination lock can be used to limit access to the inner repository. In this manner, individuals having the combination to the combination lock will have access to the key in the inner repository, thereby having access to the locked building.

A number of lockbox designs have been developed. U.S. Pat. No. 5,815,557 issued to Larson discloses a secure entry system that makes use of radio transmissions to communicate with locks, keys, and related components throughout the system. The radio transmissions can be made using a paging system, a cellular telephone system, or any other RF carrier. Some embodiments employ a cellular telephone in lieu of an electronic key. Others integrate a paging receiver within an electronic key to provide a unit with dual functionality. The system is illustrated with reference to exemplary applications in the industrial site security, real estate lockbox, and transportation fields. A homeowner key allows the homeowner greater oversight and involvement. The key includes a privacy feature, enabling the homeowner to disable the lockbox for a predetermined period if privacy is desired.

U.S. Pat. No. 5,705,991 issued to Kniffin, et al. describes a secure entry system that makes use of radio transmissions to communicate with locks, keys, and related components throughout the system. The radio transmissions can be made using a paging system, a cellular telephone system, or any other RF carrier. Some embodiments employ a cellular telephone in lieu of an electronic key. Others integrate a paging receiver within an electronic key to provide a unit with dual functionality. The system is illustrated with reference to exemplary applications in the industrial site security, real estate lockbox, and transportation fields.

U.S. Pat. No. 5,245,652 issued to Larson, et al. discloses a comprehensive real estate lockbox system which provides a variety of operational features. One of these includes a reader key that can retrieve access data from a system lockbox. The reader key is provided with an audible tone generator which can be selectively enabled by the user. The tone generator can be used to download data from the reader key over telephone lines.

U.S. Pat. No. 5,084,945 issued to Childers describes a detent clip adapted to fit around the edge of a door and positioned so that the clip prevents the swinging movement of a real estate lockbox attached to the handle of the door. The clip comprises a substantially U-shaped member, one leg of which has a projecting portion to bear against the lockbox thereby deterring its swinging movement when the door is opened or closed.

U.S. Pat. No. 5,046,084 issued to Barrett, et al. describes an electronic real estate lockbox system that includes a facsimile reporting capability. More particularly, numeric data detailing the location of a lockbox, dates and times of accesses to the lockbox, and the identities of the key holders who accessed the lockbox, is transferred from the lockbox to a central computer. The central computer interprets this numeric data to provide human-readable names, addresses, etc. After translation, the central computer formats the data for facsimile transmission to the local real estate offices that require the information to track usage of the lockbox.

U.S. Pat. No. 4,766,746 issued to Henderson, et al. discloses a comprehensive real estate lockbox system which provides a variety of operational features. Some of these features include the ability to: record all accesses to all lockboxes; transfer all or part of such records from the lockboxes to a supervising real estate agency or board; organize and review such records; facilitate operation of lockboxes that are mounted in awkward or poorly lit locations; limit lockbox accesses to preselected agents, agencies or boards; reprogram lockboxes in the field; monitor redundantly the status of the lockbox battery; record diagnostic information on each operation of a lockbox or key; render keys inoperative on predetermined dates; disable unauthorized keys; grant agents from remote real estate boards permission to open certain lockboxes, and; grant different keys different privileges.

U.S. Pat. No. 4,727,368 issued to Larson, et al. describes real estate lockbox and key designs which provide a variety of operational features. Also disclosed is a comprehensive system that allows real estate boards and agencies to efficiently manage their lockbox operations. Features provided by the system include the ability to record all accesses to all lockboxes; transfer all or part of such records from the lockboxes to the real estate agency or board; organize and review such records at the agency or board offices; disable operation of various lockboxes during certain hours of the day; facilitate operation of lockboxes that are mounted in awkward or poorly lit locations; limit lockbox accesses to pre-selected agents, agencies or boards; and record diagnostic information with each operation of a lockbox or key.

U.S. Pat. No. 6,813,912 issued to Ng, et al. describes a secure lockbox that includes an interior key lock controlling access to the mechanism for setting and changing the combination for the lock controlling access to the interior storage compartment of the lockbox. A second key lock controls the attachment bail of the lockbox, preventing unauthorized removal of the lockbox. The two key locks may be identically keyed. In a variant of the invention, a second combination lock controls the attachment bail instead of a key lock. Resilient coverings are provided for the attachment bail and the sides of the lockbox body to prevent damage to buildings and fixtures. A chain is provided to secure the door of the lockbox to the body. A slide latch having non-slip features is controlled by the door's combination lock and engages an edge of the door opening to secure the door opening.

While various improvements have been made to these traditional lockboxes over the years, certain disadvantages still remain. For example, it may be desirable for the owner of the lockbox to identify all individuals accessing the lockbox. The owner of the lockbox may also want to identify the date and time that the individual accessed the lockbox. Moreover, it is also desirable to be able to keep track of and obtain this information in an efficient and economical manner that does not include any reoccurring or hidden fees.

Given the deficiencies described above, there exists an unfulfilled need for an improved lockbox system that addresses the various disadvantages inherent to lockboxes found in the prior art.

### SUMMARY

According to the exemplary embodiments of the present invention, an electronic lockbox system is provided that maintains an access log with the dates and times of entry. Furthermore, the access log can be maintained and retrieved without the need to pay any subscription fees.

Preferably, a keypad is integrated into the lockbox through which a personal identification number (or “PIN”) can be input by a user. Upon recognition of the PIN by the lockbox, the door of the lockbox will open to expose the lockbox's inner repository. Any small item (e.g., a key) can be stored within this inner repository.

According to an embodiment of the present invention, the lockbox includes a microprocessor that controls its operations consistent with stored instructions on a permanent memory device. Memory device can be used to maintain an access log, which includes information regarding the identities of the individuals accessing the lockbox, as well as the dates and time of entry.

According to another embodiment, the memory device also includes programmed instructions that provide restrictions on the use of the lockbox. Such programmed instructions may be used to limit a user's ability to access the inner repository to a finite time period.

According to another embodiment, the inventive lockbox includes a USB socket for accepting a USB mass storage device (e.g., flash drive). In this manner, information can be transmitted to or retrieved from the memory device within the lockbox. A USB mass storage device is used to retrieve the access log from the lockbox. The access log can then be reviewed on the user's computer with a program. USB mass storage device can also be used to transmit updated programmed instructions to the lockbox to affect its functionality.

According to another embodiment, lockbox functions with a particular preprogrammed USB mass storage device, thereby preventing unwanted individuals from reprogramming or obtaining information from the lockbox.

These and other benefits of the present invention will be readily apparent from figures and detailed description of the invention provided herein.

### BRIEF DESCRIPTION OF THE DRAWINGS

The accompanying drawings, which are incorporated into and constitute a part of this specification, illustrate one or more embodiments, and together with the detailed description, serve to explain the principles and implementations of the invention. In the drawings:

FIG. 1 illustrates an exemplary embodiment of a lockbox according to the present invention.

FIG. 2 is an exemplary embodiment of lockbox in closed configuration according to the present invention.

FIG. 3 illustrates a lockbox in open configuration according to a preferred embodiment of the present invention.

FIG. 4 depicts an exemplary embodiment of lockbox in open configuration with a battery compartment according to the present invention.

FIGS. 5A and 5B are conceptual diagrams illustrating how an external storage is used with a lockbox according to a preferred embodiment of the present invention.

FIG. 6 provides an exemplary embodiment of a graphical user interface to manage lockbox access according to the present invention.

FIG. 7 is a flow chart illustrating how lockbox accessing information from an external storage according to an embodiment of the present invention.

FIG. 8 is a block diagram of an exemplary architecture that the present invention, can be implemented upon.

### DETAILED DESCRIPTION

Exemplary Embodiments are described herein in the context of a programmable electronic lockbox system. Those of ordinary skill in the art will realize that the following detailed description is illustrative only and is not intended to be in any way limiting. Other embodiments of the present invention will readily suggest themselves to such skilled persons having the benefit of this disclosure. Reference will now be made in detail to implementations of embodiments of the present invention as illustrated in the accompanying drawings. The same reference indicators will be used throughout the drawings and the following detailed description to refer to the same or like parts.

### General Overview of the Lockbox

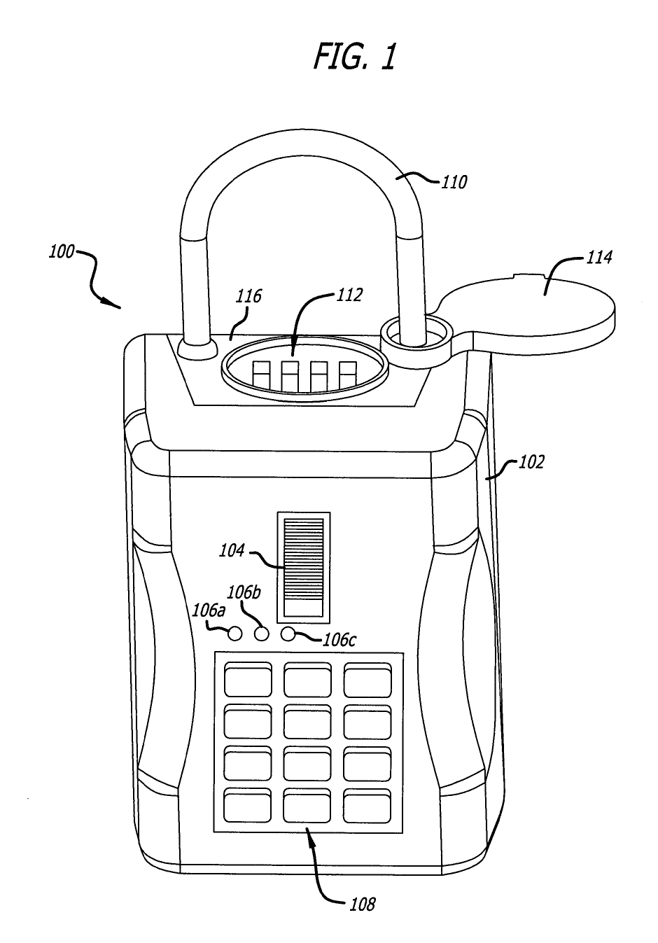

Referring to FIG. 1, an embodiment of lockbox 100 can generally be seen as including a body 102 having sliding lock lever 104, LED indicators 106a, 106b, 106c, keypad 108, attachment bail 110, combination lock 112, and combination lock cover 114.

In this embodiment of the invention, attachment bail 110 is U-shaped and extends away from the top surface 116 of body 102. Attachment bail 110 is slidable from a first open position to a second closed position in which lockbox 100 can be secured to a building structure. As with other conventional combination padlocks, combination lock 112 can be used to secure attachment bail 110 to body 102 in the closed position.

Attachment bail 110 can be moved from its closed to its open configuration by entering the correct combination into combination lock 112. The combination for combination lock 112 will have a default value. Alternatively, user can reset the combination for combination lock 112 to any desirable unlocking code. A combination lock cover 114 may be used to cover combination lock 112. Alternatively, lockbox 100 can be used without attachment bail 110 and combination lock 112.

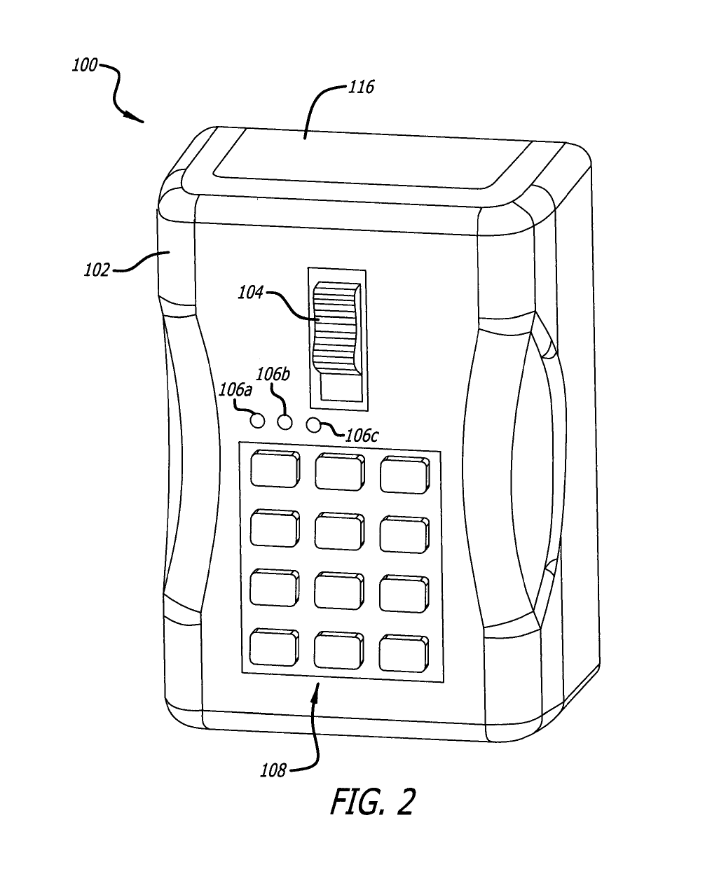

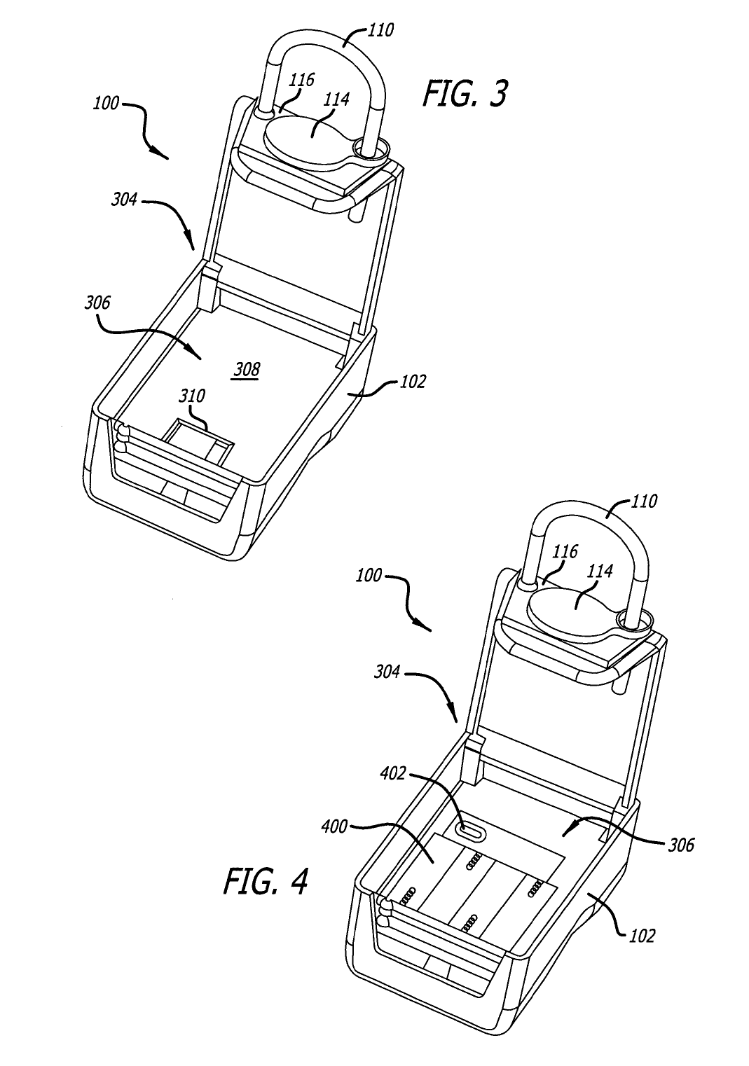

In addition to the attachment bail 110, lockbox 100 has an open and closed configuration. The closed configuration is illustrated in FIGS. 1 and 2, while the open configuration is illustrated in FIG. 3.

Referring again to FIG. 1, lockbox 100 includes a 12-button keypad 108 that allows user to enter a PIN to electronically unlock lockbox 100, upon which LED indicators 106a, 106b, 106c will light up to indicate whether an acceptable code was input. The LED indicators may be any color, for example, 106a can be red, informing the user that access was denied or that errors occurred, 106b may be orange, indicating that lockbox 100 is busy processing data, and 106c may be green, informing the user that access has been granted. LCD display may also be used to provide notifications and/or other instructions to the user regarding the user's ability to successfully unlock lockbox 100.

Once an acceptable PIN has been input by the user, the user can slide lock lever 104 to unlock lockbox 100. Sliding lock lever 104 up (toward top surface 116) will lock the lockbox 100, and sliding lock lever 104 down (away from top surface 116) will unlock lockbox 100.

Referring now to FIG. 3, lockbox 100 is illustrated in its open configuration. As shown in FIG. 3, this embodiment of the inventive lockbox 100 can generally be described as having front half 300 and back half 302. Front half 300 is pivotally attached to back half 302 along the bottom 304 of lockbox 100. Pulling down front half 300 (so that it pivots away from back half 302) exposes inner cavity 306. Inner cavity 306 within lockbox 100 provides the area in which a key, access card, etc. can safely be stored. Lockbox 100 can further be seen as including cover 308 and sliding lever 310 on the inner surface of front half 300.

Moving sliding lever 310 to its open configuration will allow the user to remove cover 308. FIG. 4 illustrates lockbox 100 in its open configuration once sliding lever cover 308 has been removed. As shown in FIG. 4, lockbox 100 includes battery compartment 400 and USB port 402. The functionality of USB port 402 will be described in greater detail below.

Lockbox 100 is illustrated as accepting four AA batteries to power lockbox 100. When the battery power drops below an acceptable level, the lockbox will start beeping. If the batteries completely die, lockbox 100 will not have the power to accept a PIN through keypad 108. Accordingly, lockbox 100 can be equipped with an external power inlet. In this manner, lockbox 100 can be powered by an external battery pack to allow a user to input the correct PIN to open lockbox 100.

### Use of a USB Mass Storage Device with the Lockbox

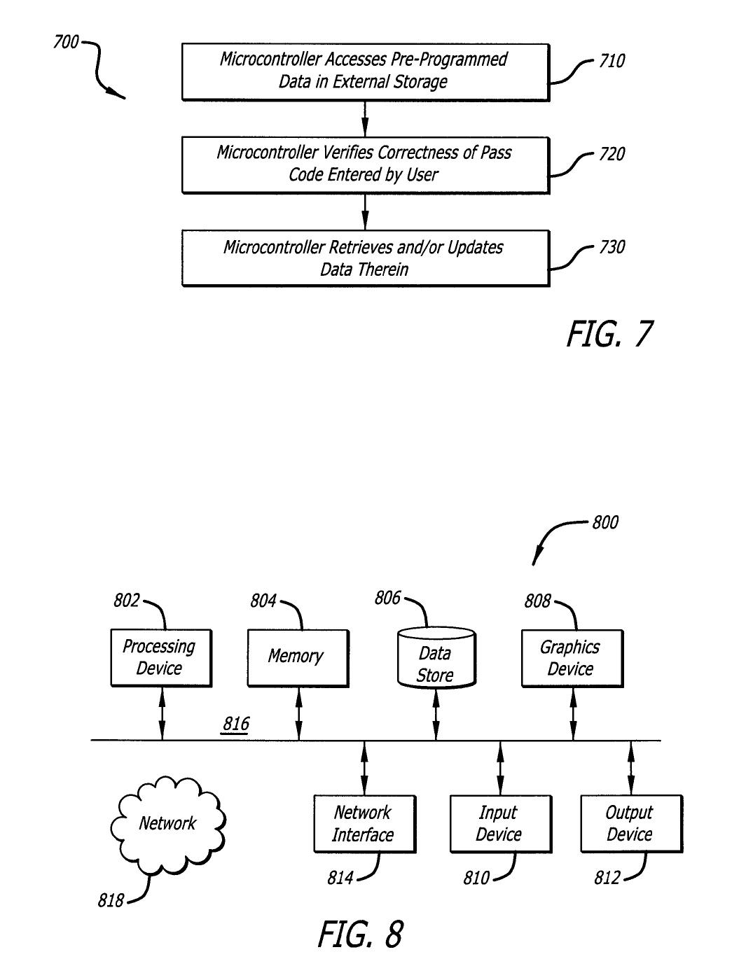

FIG. 7 provides a flow chart in accordance with a preferred embodiment of the present invention, illustrating lockbox 100 accessing information from a pre-programmed external storage, in response to user activation. Referring to FIG. 7, a microcontroller is incorporated into the design of the Lockbox 100. The microcontroller is capable of retrieving information from and storing information to the pre-programmed external storage. The pre-programmed external storage is advantageously a USB mass storage device such as flash drive, which can be connected to the lockbox 100 through USB port 402 (as shown in FIG. 4). This allows the user to retrieve and update the lockbox 100's microcontroller without engaging the services of an outside entity and incurring subscription fees, or pay for any other subscription based services.

When the user plugs the pre-programmed external storage into the USB port 402 of lockbox 100, the microcontroller accesses the data in the external storage (Step 710). In a preferred embodiment, lockbox 100 requires the user to enter pass code to enable the microcontroller to access data. The microcontroller then verifies whether the pass code entered is correct (Step 720). If the microcontroller is unable to find the pre-programmed data from the external storage and a correct pass code in coexistence, the accessing process is aborted. Alternatively, lockbox 100 remains locked when missing the required information. Under another alternative, if either of a correct pass code and pre-programmed data is missing, lockbox 100 is triggered to issue alerting signals such as beeps or red flash.

Upon detecting the pre-programmed data and correct pass code, the microcontroller is activated to retrieve and/or update the data stored therein (Step 730). Accordingly, a user can store, retrieve, append and delete data (e.g., date and time information, passwords, PIN information, access logs, etc.) from the lockbox 100's microcontroller using the external storage, e.g., USB mass storage device.

In some embodiments, the external storage is a wireless device that can communicate remotely with the microcontroller. The wireless device may be a cell phone, pager, PDA, RF carrier, Bluetooth device, etc. The lockbox 100 incorporates a transmission module connected to the microcontroller for receiving signals such as Bluetooth or other radio waves. The signals carry pass code or pre-programmed data, upon receiving and verifying which the lockbox 100 is opened.

The pass code and pre-programmed data, as depicted below, can be transferred from a computer system that implements the underlying software, to a portable (flash) drive as well as a wireless device. The microcontroller within lockbox 100 is capable of recording the pass code or pro-programmed data that has been used to access lockbox 100. Because the computer software associates users with the particular pre-programmed data and pass code given to them, the administrator of the present invention can keep track of which users have accessed lockbox 100 and related data such as time and date.

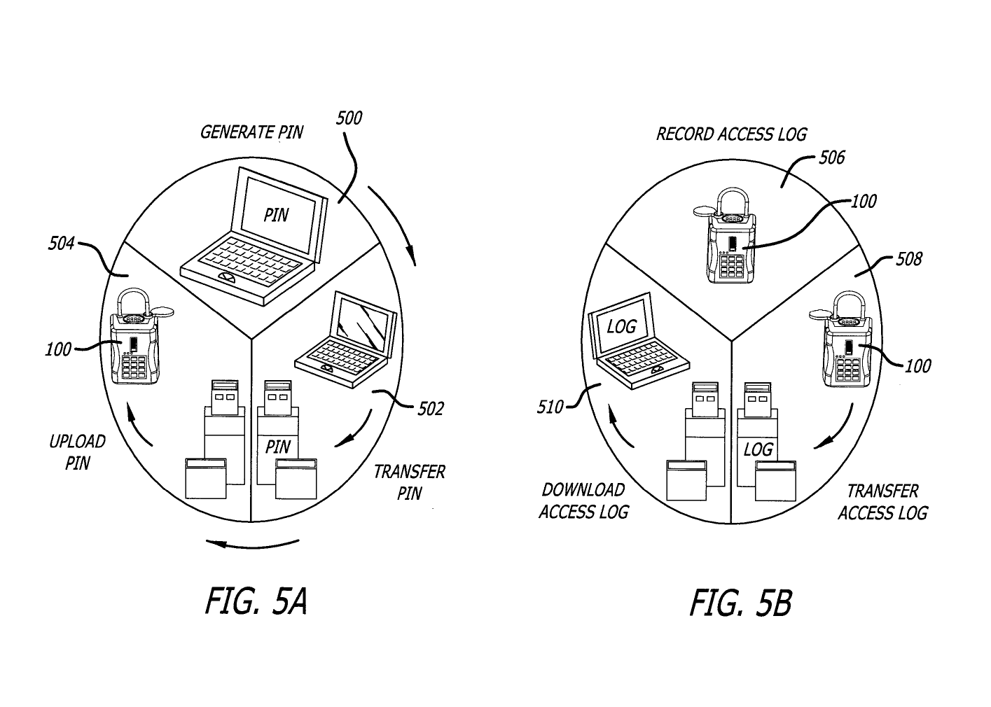

FIGS. 5A and 5B provide conceptual illustrations of how a USB mass storage device can be used with lockbox 100. Referring now to FIG. 5A, step 500 illustrates a computer that includes software capable of generating unique PINs to be assigned to the individuals who will be given access to the lockbox. In step 502, the PINs are transferred from the computer to a flash drive. In step 504, the PINs on the flash drive are transferred to the lockbox through a USB port on the lockbox. In this manner, lockbox 100 will be capable of differentiating and tracking all of the different users who access inner cavity 306 of lockbox 100.

Referring now to FIG. 5B, step 506 generally illustrates a lockbox including a recorded access log that has been stored on the lockbox's microcontroller. The access log is transferred to a flash drive in step 508, and then transferred to a computer in step 510. Once the access log has been transferred to the computer, the owner of the lockbox will be able to easily review the lockbox's access log.

The USB mass storage device used with lockbox 100 may be password protected so that only those individuals who know the password can use the USB device. In another embodiment, lockbox 100 will only work with a single USB device that has been specifically programmed to work with a single, specific lockbox. In yet another embodiment, the USB device used with the lockbox will be custom made to include dual partitions. In this manner, the first partition is not accessible by the user, but can still be used to store, retrieve, append and delete data through the use of the lockbox and its related software. The second partition would function as typical USB device where the user can store any related or unrelated information on the USB device.

### Lockbox Password Manager

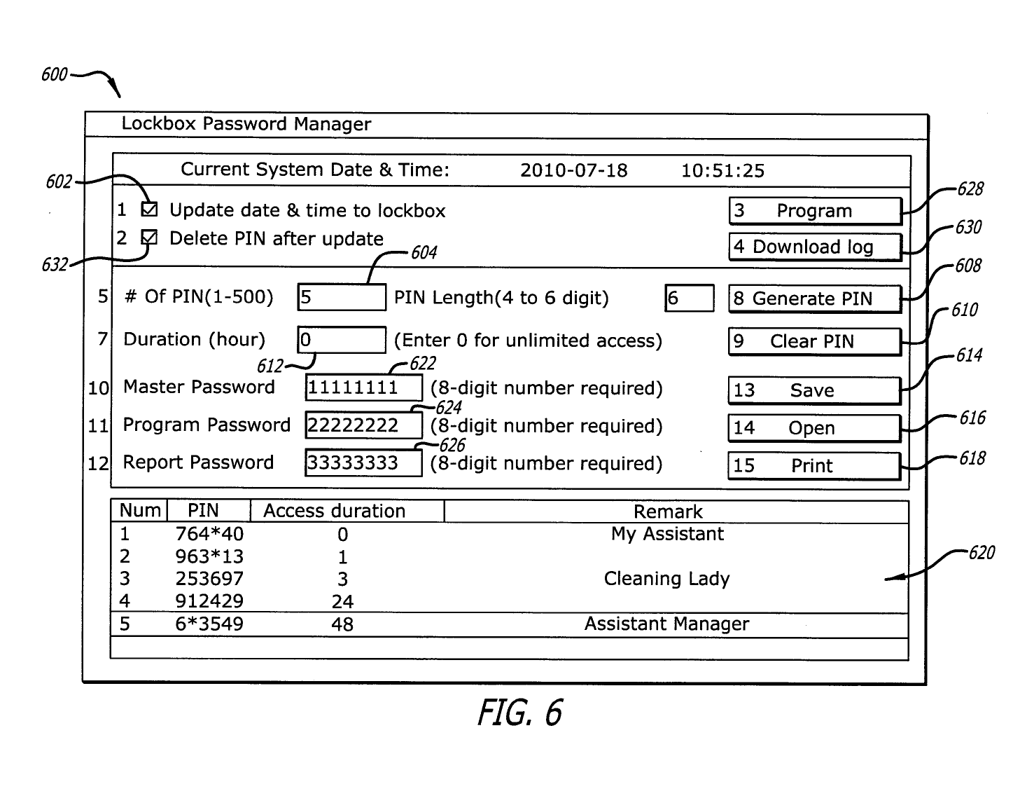

Referring now to FIG. 6, a graphical user interface from a software program used to manage lockbox 100 is illustrated. As shown in FIG. 6, LockBox Password Manager 600 includes several input boxes and command buttons that a user can use to manage lockbox 100. The specific input boxes and command buttons employed in the embodiment illustrated in FIG. 6 can generally be described as follows.

Input box 602 gives the user the option of updating the date and time information displayed by Password Manager 600, which can in turn be transferred to lockbox 100. In an embodiment, checking input box 602 causes Password Manager 600 to pull date and time information from the user's computer. In this embodiment, the date and time information is displayed adjacent to the top of Password Manger 600.

As set forth above, a PIN is an identifying number that can be assigned to each individual user of lockbox 100. Input boxes 604, 606, and 612 as well as command buttons 608 and 610 can be used to generate, edit, and delete PINs to be used by lockbox 100. Specifically, input box 604 can be used by the user to create a certain number of PINs. As shown in FIG. 6, the user has indicated that 5 PINs should be created through input box 604. Input box 606 can be used by the user to select the PIN's length. As shown in FIG. 6, the user has indicated that the PIN should have 6 digits through input box 606. Selecting command button 608 will cause Password Manger 600 to generate PINs based on the user's desired settings. Selecting command button 610 will cause Password Manager 600 to delete all previously generated PINs. Input box 612 can be used by the user to specify the duration of the access time permitted for each user. For example, the user can direct Password Manager 600 to generate a PIN that includes an access time of “48.” Here, the user will have access to lockbox 100 for 48 hours after the initial use. The user can type in “0” for unlimited access. Selecting command button 614 allows the user to save generated PINs along with their settings. Selecting command button 616 allows the user to open previously generated PIN files. Selecting command button 618 allows the user to print generated PINs.

In this embodiment, graphical user interface window 620 displays the number of PINs that have been generated, the exact PINs, and the assigned access durations for the PINs. In an embodiment, a user can edit the PINs and access duration information for each individual PIN directly within window 620. Furthermore, the user can input remarks into window 620 for the individual PINs so the user can easily see who has been assigned to a particular pin number. In the example illustrated in FIG. 6, the PIN254697 has been assigned to the cleaning lady.

In certain embodiments of the invention, Password Manager 600 can be used to set custom passwords for lockbox 100. For example, in input box 622, the user can set up a mater password to provide unlimited access to lockbox 100. This password will work even if all PINs have expired. As another example, in input box 624, the user can set up a program password which enables users to upload PINs and date/time information from the USB device to lockbox 100. As yet another example, in input box 626, the user can set up a report password that enables users to download access logs from lockbox 100 to the USB device. Password Manager 600 illustrated in FIG. 6 indicates that 8-digit numbers are required for input boxes 622, 624 and 626. Other embodiments of the invention, however, may have different requirements (i.e., more or less required digits) and still fall within the scope of the invention.

Still referring to FIG. 6, a user can click on command button 628 to transfer the PINs to the USB device. Along the same lines, a user can click on command button 630 to download access logs from the USB device to the computer. Finally, checking input box 632 will result in the PINs being automatically removed from the USB device as soon as they are uploaded to lockbox 100.

FIG. 8 is a block diagram of an exemplary architecture 800 that the present invention, particularly the Password Manager 600, can be implemented upon. The example architecture 800 includes at least one processing device 802 coupled to a bus system 816 to transmit data, such as a data bus and a mother board. The example architecture 800 further includes the following units connected to the bus system 816: data store 806, memory 804, input device 810, output device 812, graphics device 808, and network interface 814.

The processing device 802 for executing programs or instructions can be or include general and special purpose microprocessors that incorporate functions of a central processing unit (CPU) on a single integrated circuit (IC). The CPU controls an operation of reading the information from the data store 806, for example.

The data store 806 or memory 804 both serve as computer data storage for the example architecture 800 to buffer or store data, temporarily and permanently. The computer data storage refers to computer components, devices, and recording media that retain digital data used for computing for some interval of time. The data store device 806 typically includes non-volatile storage device such as magnetic disks; magneto-optical disks; and CD-ROM and DVD-ROM disks. The memory 804 include all forms of non-volatile memory, including but not limited to semiconductor storage known as EPROM, EEPROM, flash memory devices, and dynamic random access memory, for example.

Examples for the input device 810 include a video camera, a keyboard, a mouse, a trackball, a stylus, etc.; and examples for output devices 812 can include a display device, an audio device, etc. The display monitors such as cathode ray tube (CRT) or liquid crystal display (LCD) monitor for displaying information to a user.

The graphics device 808 can, for example, include a video card, a graphics accelerator card, a graphics processing unit (GPU) or a display adapter, and is configured to generate and output images to a display device. In one implementation, the graphics device 808 can be realized in a dedicated hardware card connected to the bus system 816. In another implementation, the graphics device 808 can be realized in a graphics controller integrated into a chipset of the bus system 816.

The network interface 814 can, for example, include a wired or wireless network device operable to communicate data to and from a network 818. The network 818 may include one or more local area networks (LANs) or a wide area network (WAN), such as the Internet.

In one implementation, the system 800 includes instructions defining an operating system stored in the data store 806 and/or the memory 804. Example operating systems can include the MAC OS.®. X series operating system, the WINDOWS.®. based operating system, or other operating systems. Upon execution of the operating system instructions, access to various system objects is enabled. Example system objects include data files, applications, functions, windows, etc. To facilitate an intuitive user experience, the system 800 may include graphical user interface that provides the user access to the various system objects and conveys information about the system 800 to the user in an intuitive manner.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modification that are suited to the particular use contemplated. It is intended that the scope of the invention be defined by the claims and their equivalents.

1. A programmable lock system for restricting access and user tracking, the system comprising:
a lock mechanism having a locked state and an unlocked state;
a microcontroller operatively connected with the lock mechanism; and
an input device operatively connected with the microcontroller for receiving passing information, wherein the microcontroller reads the received passing information and determines whether to unlock the lock mechanism

2. The lock system of claim 1, further comprising an inlet operatively connected with the microcontroller for receiving an external storage, wherein the external storage provides pre-programmed code based on which the microcontroller determines whether to retrieve or provide data contained within the microcontroller.

3. The lock system of claim 2, further comprising:
a computer implemented manager program, wherein the manager program generates the passing information for a particular user and stores the passing information to the external storage for uploading to the microcontroller.

4. The lock system of claim 3, wherein the microcontroller implements an access log for recording the passing information for multiple users, the access log being transferrable to the manager program for tracking the multiple users' access.

5. The lock system of claim 2, wherein the external storage is a USB mass storage device.

6. The lock system of claim 3, wherein the manager program provides one of the following functions:
generating multiple sets of passing information for different users; and
displaying the multiple sets of passing information.

7. The lock system of claim 3, wherein the manager program receives user remarks for the passing information and displays the user remarks along with the passing information.

8. The lock system of claim 3, wherein the manager program includes at least one of the following functions:
editing the passing information; and
deleting the passing information.

9. The lock system of claim 2, wherein the passing information is generated according to user parameters, including at least one of the following:
length of the passing information; and
duration of the passing information.

10. The lock system of claim 1, wherein the lock mechanism comprises:
a body having two halves attached pivotally to each other, wherein a cavity is formed between the two halves when they are closed;
a keypad mounted on the body for receiving the passing information and transmitting the received information to the microcontroller to determine its correctness;
an indicator mounted on the body for showing the microcontroller's determination as to the correctness of the received information;
an electro-magnetic lock mounted on the body for holding the two halves together in locked status, wherein the electro-magnetic lock is released to free the two halves when the received information is determined by the microcontroller to be correct.

11. The lock system of claim 10, further comprising:
a lever that can slide between an open configuration and a closed configuration in response to the microcontroller's determination as to the correctness of the received information, wherein the lever is movable to the open configuration from the closed configuration only when the microcontroller determines the received information is correct, and the lever stays locked in the closed configuration when the microcontroller determines the received information is incorrect.

12. The lock system of claim 1, wherein the lock mechanism comprises:
a body;
an attachment bail that slidably attaches to the body and is movable between an open position and a closed position relative to the body for securing the lock mechanism to an object; and
a combination lock that secures the attachment bail to the body, wherein the attachment bail can be moved from the closed position to the open position when the combination lock receives correct combination.

13. The lock system of claim 12, wherein the lock mechanism further comprises a cover to shelter the combination lock.

14. The lock system of claim 10, wherein the indicator is a liquid crystal display.

15. The lock system of claim 10, wherein the indicator comprises one or more light-emitting diode lights.

16. The lock system of claim 10, wherein the body further comprises a battery compartment or for receiving power to charge at least the microcontroller.

17. The lock system of claim 10, wherein the body further comprises an external power inlet for receiving power to charge at least the microcontroller.

18. The lock system of claim 1, wherein the microcontroller requires entering a correct pass code before starting to access the external storage device.

19. The lock system of claim 1, further comprising:
a transmission device operatively connected with the microcontroller for receiving and transmitting signals; and
a wireless device for communicating the signals with the transmission device, wherein the signals carry pre-programmed code data based on which the microcontroller determines whether to retrieve or provide data contained within the microcontroller.

20. The lock system of claim 19, wherein the wireless device includes one of the following:
a cell phone;
a RF carrier; and
a pager.
